(19) United States
(12) Patent Application Publication
(10) Pub. No.: US 2013/0208924 A1
(43) Pub. Date: Aug. 15, 2013

(54) LOUDSPEAKER WITH REVERSIBLE SOUND PORT

(71) Applicants: David A. Wilson, Provo, UT (US); Daryl Conrad Wilson, Provo, UT (US); Walter Vern Credille, Provo, UT (US); Robert Blake Schumtz, Provo, UT (US)

(72) Inventors: David A. Wilson, Provo, UT (US); Daryl Conrad Wilson, Provo, UT (US); Walter Vern Credille, Provo, UT (US); Robert Blake Schumtz, Provo, UT (US)

(21) Appl. No.: 13/372,377

(22) Filed: Feb. 13, 2012

(51) Int. Cl. H04R 25/00

(52) U.S. Cl. 381/150

(57) ABSTRACT

A speaker is provided with multiple sound ports and a port plug. The sound port plug is used to close one of the sound ports while leaving the other sound port open to transmit sound. The speaker may have a first sound port located on the front of the speaker and a second sound port located on the rear of the speaker. In using the speaker, a person selects between the front port and the rear port and closes the undesired sound port.

### THE FIELD OF THE INVENTION

The present invention relates to speakers. More specifically, the present invention relates to a speaker design with a reversible sound port.

### BACKGROUND

Speakers are used for many purposes. Beyond the many businesses which rely on music or other sounds, increasing numbers of individuals have home theaters, music listening rooms or advanced stereo systems in their homes. Even home speaker users now demand better reproduction of music, movie soundtracks or other sounds and require speakers which provide an optimum listening experience. Those users with speakers which are used for high end listening rooms, studio monitors, theater speakers, etc. typically require their speakers to reproduce the music or sounds very accurately. Speakers are required to provide an ever more perfect presentation of the listener's music. Distortion or other deficiencies in the presentation of the music are not tolerated.

Ideally the energy, or sound, produced in a room by a speaker should be constant as a function of frequency. The various sound frequencies should be consistent and there should not be frequencies where the speaker output is too strong or not well reproduced. Rooms, however, alter the linearity of resident loudspeakers in ways that have been studied for many decades. In the low frequencies, one of the significant influences on the resulting strength of the reproduction of the sound is the distance between the loudspeakers bass source and a reflective wall.

For speakers with ported enclosure designs, the woofer driver itself radiates most of the low frequency energy in the lower midrange frequencies down to the upper bass frequencies. However, at lower sound frequencies such as from the mid-bass down into the lower bass, the speaker port itself projects most of the sound energy into the room. Experience has borne out that if the speaker port is closer to a reflective object such as a wall, its output will be reinforced more than it would be if it were further from the wall. The location of the port on the loudspeaker enclosure will, therefore, be a factor in the low frequency response of the loudspeaker system after the system is placed in the room.

In placing speakers in a room, there are many competing concerns. As discussed above, speaker location will affect the reinforcement of low frequencies emitted from a port. Speaker location may also be dictated by the optimum placement for higher frequency sounds. In many situations, the shape of a particular room or user requirements for a room such as furniture layout may affect the location of a speaker and may not permit placement of the speaker for optimum sound production. Often, the speaker location which yields the best mid-range musicality and the most palpable stereo sound stage imagery is not the best location for appropriate and effective bass reinforcement.

There is thus a need for increased flexibility in adjusting the speaker output to tailor the speaker output to the particular placement in a room. In particular, there is a need for increased flexibility in adjusting the port of a ported speaker enclosure to compensate for placement of the speaker within the room and thereby cause the speaker to produce sound energy which is constant as a function of frequency within the room.

### SUMMARY OF THE INVENTION

It is an object of the present invention to provide an improved loudspeaker design.

According to one aspect of the invention, a speaker is provided which includes two sound ports and which includes a plug to close one of the sound ports. In use, one of the sound ports is plugged and all of the sound energy is emitted from the other sound port.

According to another aspect of the invention, the two sound ports are located at different locations on the speaker. The two sound ports may be located on the front and back of the speaker cabinet. Providing the speaker installer with 2 port location options increases the likelihood of successfully integrating very high quality bass with an overall satisfying response throughout the rest of the audible spectrum.

These and other aspects of the present invention are realized in a speaker as shown and described in the following figures and related description.

### BRIEF DESCRIPTION OF THE DRAWINGS

Various embodiments of the present invention are shown and described in reference to the numbered drawings wherein:

FIG. 1 shows a front view of speaker according to the present invention;

FIG. 2 shows a shows a rear view of the speaker of FIG. 1;

FIG. 3 shows a detailed view of the front of the speaker of FIG. 1;

FIG. 4 shows a cross sectional view of the speaker taken along line A-A of FIG. 3;

FIG. 5 shows a cross sectional view of the speaker taken above the cross section of FIG. 4;

FIG. 6 shows the speaker port plug as shown in FIG. 1;

FIG. 7 shows a perspective view of the bottom of the speaker of FIG. 1 showing insertion of the port plug; and

FIG. 8 shows a cross sectional view of the speaker taken along line A-A of FIG. 3.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

As has been discussed above, a challenge in placing speakers in a listening room is achieving a balanced and pleasing sound response. It is often desirable that the sound energy which is produced by the speaker is consistent for different frequencies of sound. The upper sound frequencies are dominantly radiated by the drivers themselves into the room. The mid-bass and lower bass frequencies, however, are largely projected into the room by the speaker port. The energy level of these sound frequencies in the room is heavily dependent on the design of the sound port in the speaker cabinet and on the positioning of the speaker relative to objects which reflect sound, such as walls.

Speakers which have a sound port in the front of the cabinet emit sound energy differently than speakers which have a sound port in the rear of the cabinet. This is particularly true when considering the positioning of the speaker relative to a wall or other reflecting object. In order to provide an optimum listening experience, the location of a speaker within a room is largely dictated by the sound energy produced in the room. That is to say that the resulting sound production largely dictates the speaker placement. In many situations, however, functional limitations or space limitations of a listening room necessitate placement of a speaker in a position which is not the optimal position for sound production.

The present invention provides a person with greater options for positioning a speaker within a room while optimizing the listening experience. The present invention also provides a person with greater options for optimizing sound production for a given speaker location. This may be achieved through the use of two different sound ports which are formed in the speaker cabinet and a port plug which is used to plug one of the sound ports.

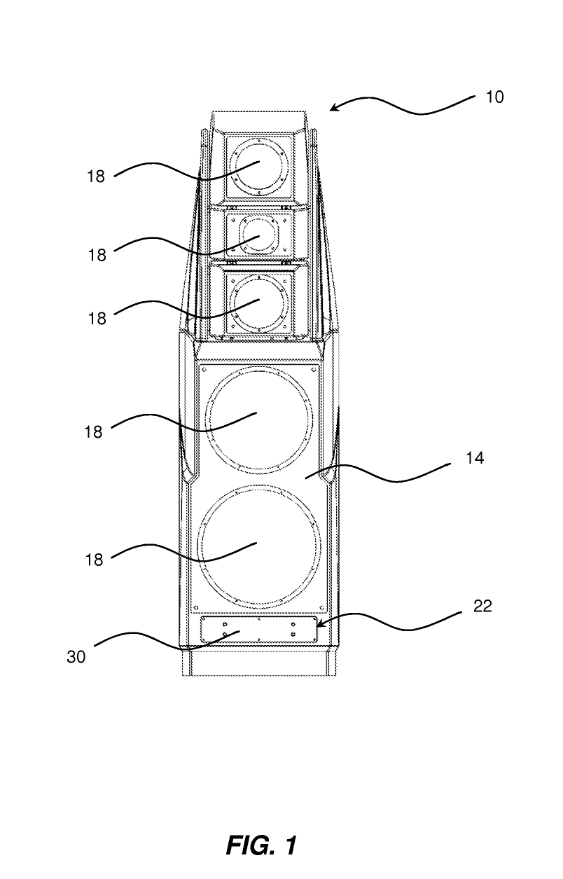

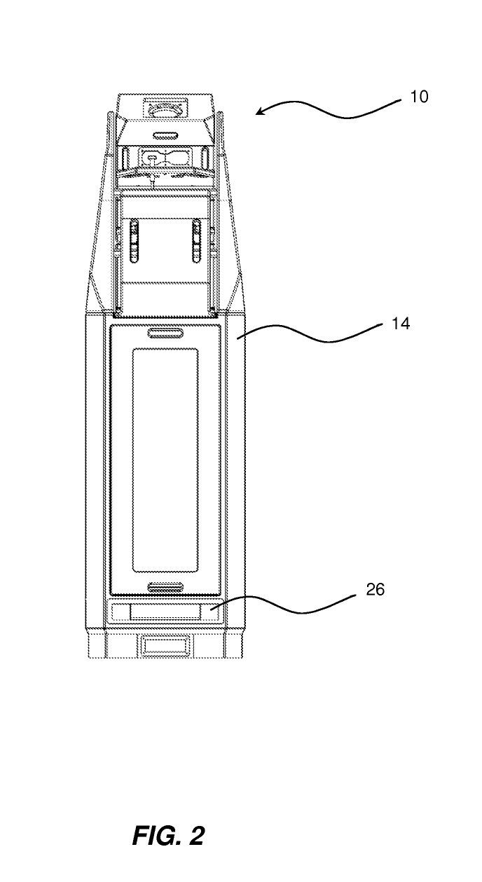

Turning now to FIGS. 1 and 2, front and rear views of a speaker according to the present invention are shown. The speaker 10 includes a speaker cabinet 14 and various speaker drivers 18. As is common with full range speakers, the speaker drivers 18 include woofers, midrange drivers and tweeters. The speaker cabinet 14 includes a first sound port 22 and a second sound port 26. In particular, the speaker 10 includes a front sound port 22 and a rear sound port 26. The front sound port 22 and the rear sound port 26 may be disposed in a linear arrangement, placing the front sound port 22 and the rear sound port 26 opposite each other on the front and rear of the speaker cabinet. The front sound port 22 has been closed with a port plug 30.

In placing the speaker 10 in a room, a person may choose between using the front sound port 22 and the rear sound port 26 by installing the plug 30 in the sound port which is not used. Changing between use of the front port 22 and the rear port 26 will alter the levels of the lower sound frequencies in the room, allowing a person to adjust the energy levels of these ported lower frequencies as may be necessary to accommodate a particular speaker position.

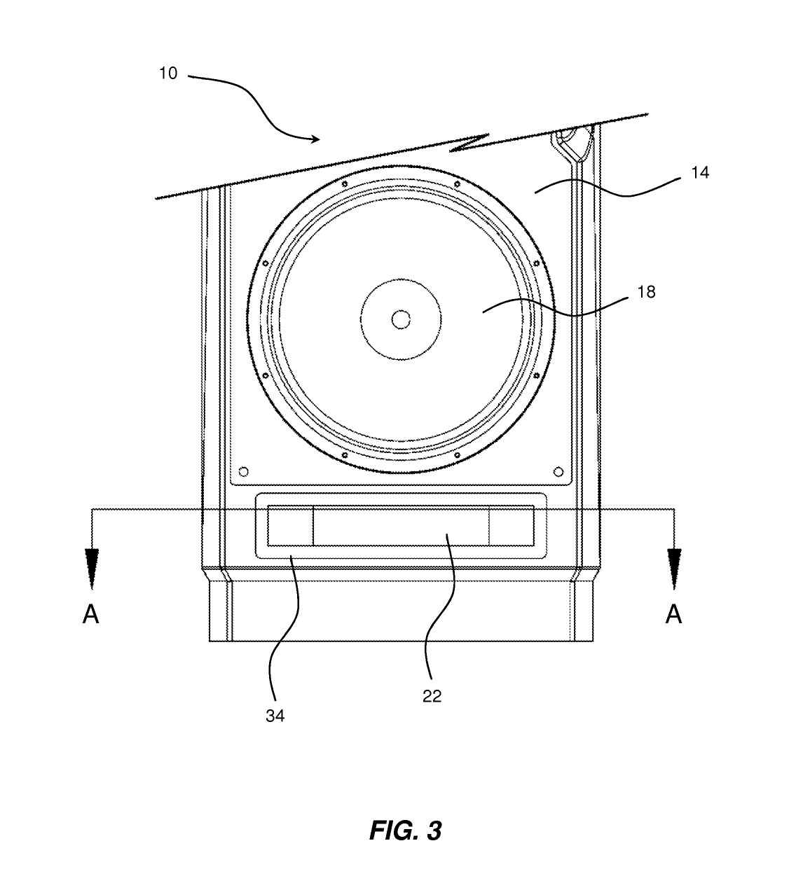

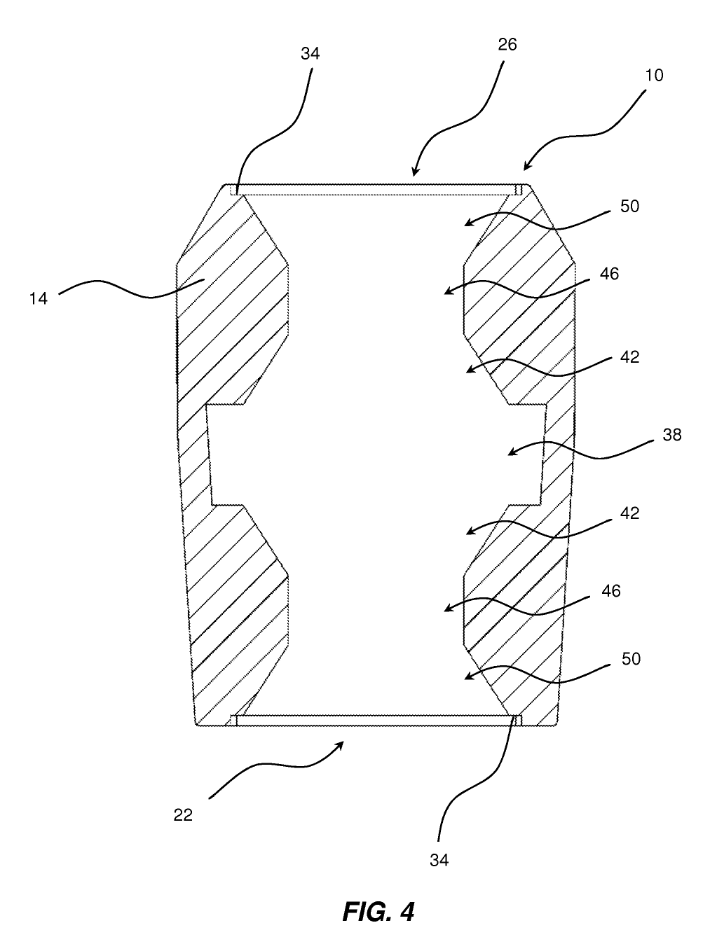

FIG. 3 shows a front view of a bottom portion of the speaker 10. A recess 34 is formed around the port 22 to facilitate attachment of the port plug 30. FIG. 4 shows a cross section taken along line A-A of FIG. 3. The speaker cabinet 14 is configured to place the front port 22 and the rear port 26 in alignment with each other as is shown. An open center plenum 38 is located between the front port 22 and the rear port 26. According to the illustrated port design, the front port 22 and rear port 26 are symmetrical, having the same shape. The front port 22 and the rear port 26 are formed with an inner transition 42, a port conduit 46 and an outer transition 50. The inner transition 42 provides a gradual transition between the center plenum 38 and the port conduit 46. The outer transition 50 provides a gradual transition between the port conduit 46 and the front or rear face of the speaker cabinet 14.

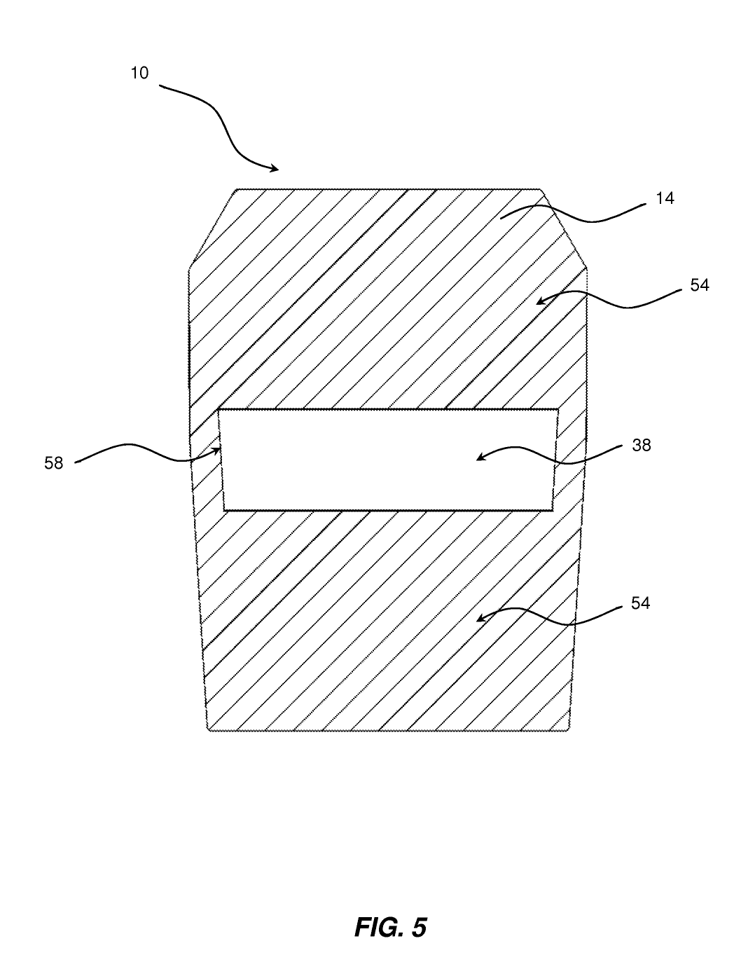

FIG. 5 shows a cross sectional view of the speaker cabinet 14 taken slightly above line A-A of FIG. 3 so as to be just above the front port 22 and rear port 26. It can be seen that the speaker cabinet 14 provides solid surfaces, generally indicated at 54, which enclose the front port 22 and rear port 26. An opening 58 is formed in alignment with the center plenum 38. Sound from the woofers is transmitted through the opening 58, into the center plenum 38 and through the front port 22 or the rear port 26 into the listening room, depending on the speaker configuration.

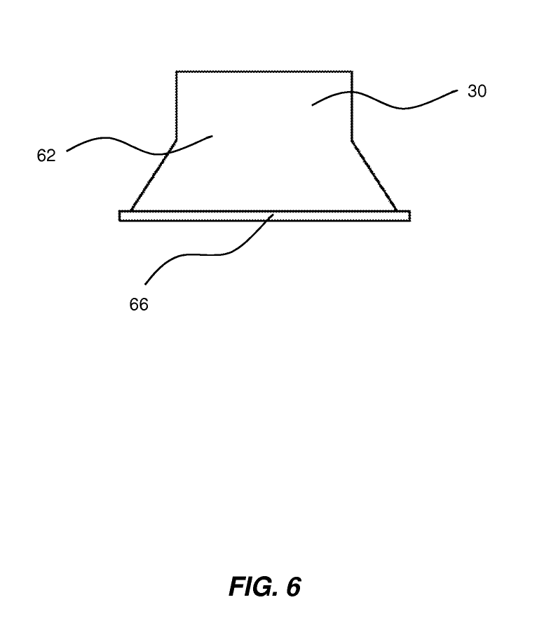

FIG. 6 shows a plug 30 which is used to close the front port or the rear port. The plug 30 includes a body 62 and a faceplate 66. The body of the plug 62 is shaped to be received into a port conduit 46 and outer transition 50 to fill these areas. The faceplate 66 fits within the recess 34 formed in the speaker cabinet. The faceplate 66 may be utilized to secure the plug 30 to the speaker cabinet 14 with screws. This may prevent the plug from moving from the installed position unintentionally and may also prevent any rattles or undesired noises. The plug 30 is designed to close off the front port 22 or the rear port 26.

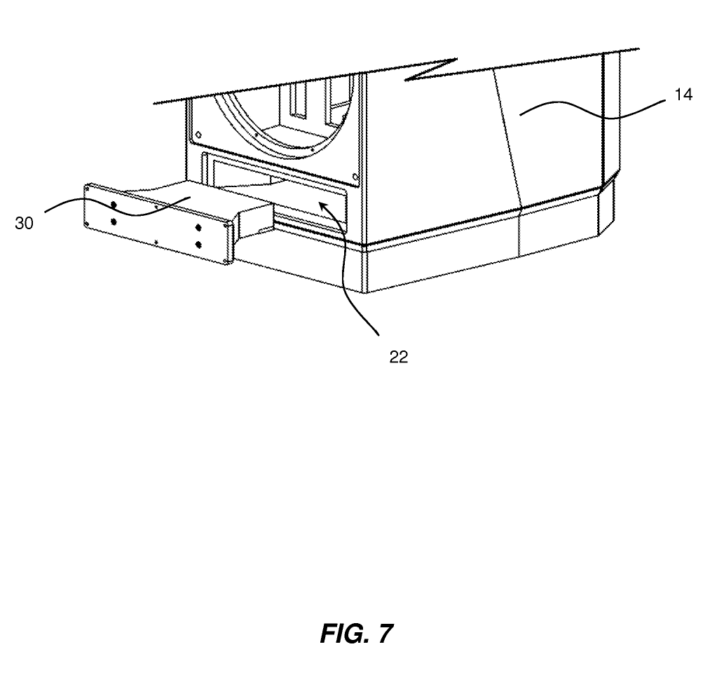

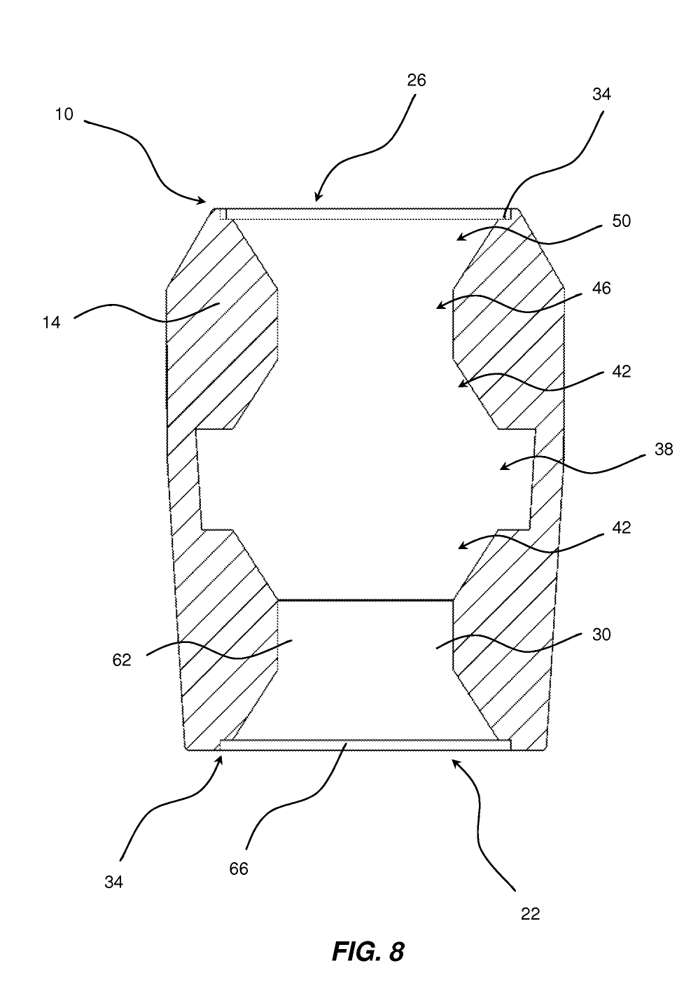

FIG. 7 shows the plug 30 during insertion into the front port 22 of the speaker cabinet 14. It is observed how the shape of the plug may correspond to the shape of the port 22 so as to fill the port when fully inserted. FIG. 8 shows a cross section of the speaker cabinet along the line A-A (the same view shown in FIG. 3) with a plug 30 inserted into the front port 22. The plug 30 complements the port shape and fills the port 22. It is seen how the center plenum 38 is left open, allowing sound to pass through the plenum 38, into the rear port 26 and our of the speaker cabinet. Similarly, the plug 30 can be placed into the rear port 26, causing the lower sound frequencies to pass through the front port 22 and out of the front of the speaker cabinet 14.

The use of two ports and a plug which closes one of the ports allows a person to quickly and easily change the port location on a speaker. A single speaker cabinet 14 may be manufactured which allows a person to use either a front port or a rear port. The plug faceplate 66 can be made to match the speaker cabinet faceplate or the surface finish of the speaker cabinet, making the plug 30 blend in with the speaker cabinet 14 so that the closed port does not detract visually from the speaker.

There is thus disclosed an improved speaker with reversible sound port. It will be appreciated that numerous changes may be made to the present invention without departing from the scope of the claims.

What is claimed is:

1. A speaker comprising:
a speaker cabinet having a front side and a back side;
a speaker driver mounted to the cabinet, the speaker driver producing sound therefrom;
a front sound port formed in the front of the speaker cabinet and extending into the cabinet;
a rear sound port formed in the rear of the speaker cabinet and extending inwardly into the cabinet; and
a port plug, the port plug being selectively disposable in one of the front sound port or the rear sound port to block the sound port and thereby cause sound to be emitted from the other of the front sound port and the rear sound port.

2. The speaker of claim 1, wherein the speaker driver is a woofer.

3. The speaker of claim 1, wherein the front sound port and the rear sound port are disposed in alignment with each other.

4. The speaker of claim 1, wherein the front sound port has a shape which is the same as a shape of the rear sound port.

5. The speaker of claim 4, wherein the port plug has a shape which corresponds to the shape of the front sound port and to the shape of the rear sound port.

6. The speaker of claim 1, wherein the front sound port and the rear sound port are sized to emit bass frequencies therefrom.

7. The speaker of claim 1, wherein the speaker comprises a center plenum disposed between the front sound port and the rear sound port and connecting the front sound port to the rear sound port.

8. The speaker of claim 7, wherein the port plug is inserted into one of the front sound port and the rear sound port to close the sound port without closing the center plenum.

9. The speaker of claim 1, wherein the port plug has a body and a faceplate, and wherein the faceplate is selectively fastenable to the speaker cabinet.

10. A speaker comprising:
a speaker cabinet having an interior;
a speaker driver attached to the speaker cabinet, the speaker driver being electrically controllable to emit sound energy therefrom;
a first sound port attached to the speaker cabinet and having an opening extending into the interior of the speaker cabinet;
a second sound port attached to the speaker cabinet and having an opening extending into the interior of the speaker cabinet; and
a port plug for selective placement in one of the first sound port and the second sound port to thereby close the sound port.

11. The speaker of claim 10, wherein the first sound port and the second sound port are located on different sides of the speaker cabinet.

12. The speaker of claim 10, wherein the first sound port is located on a front side of the speaker cabinet and the second sound port is located on a rear side of the speaker cabinet.

13. The speaker of claim 10, wherein the first sound port is disposed opposite the second sound port.

14. The speaker of claim 10, wherein the first sound port has an interior shape which is the same as an interior shape of the second sound port.

15. The speaker of claim 14, wherein the port plug has an exterior shape which corresponds to the interior shape of the first sound port.

16. The speaker of claim 10, wherein the port plug is secured to the speaker with fasteners.

17. A method of adjusting the sound output of a speaker comprising:
selecting a speaker having a cabinet, a speaker driver, a first sound port, a second sound port and a port plug;
placing the port plug in one of the first sound port and the second sound port to prevent sound from passing therethrough and thereby causing sound to be emitted from the other of the first sound port and the second sound port.

18. The method of claim 17, wherein the first sound port and the second sound port are located on different sides of the speaker cabinet.

19. The method of claim 17, wherein the first sound port is located on a front side of the speaker cabinet and the second sound port is located on a back side of the speaker cabinet.
